(19) United States
(12) Patent Application Publication
(10) Pub. No.: US 2023/0100753 A1
(43) Pub. Date: Mar. 30, 2023

(54) OUTER ROTOR MOTOR

(71) Applicant: LG ELECTRONICS INC., Seoul (KR)

(72) Inventors: Changwoo SUNG, Seoul (KR); Kyunghwan KIM, Seoul (KR); Minjung KIM, Seoul (KR)

(21) Appl. No.: 17/895,434

(22) Filed: Aug. 25, 2022

(30) Foreign Application Priority Data
Sep. 29, 2021 (KR) 10-2021-0128676

(51) Int. Cl. H02K 9/06; H02K 7/00; H02K 21/22

(52) U.S. Cl. CPC H02K 9/06; H02K 7/003; H02K 21/22

(57) ABSTRACT

An outer rotor motor includes a frame, a stator disposed on the frame, a coil disposed on the stator, a rotating shaft rotatably coupled to a central region of the frame, a cover coupled to the rotating shaft and surrounding the stator, and a magnet disposed on the cover and facing the stator. The cover may include a fan bracket projecting in a radial direction from a radially outer surface, and a plurality of blades extending in an axial direction from the radially outer surface.

### CROSS-REFERENCE TO RELATED APPLICATION

This application claims priority to and the benefit of Korean Patent Application No. 10-2021-0128676 filed in the Korean Intellectual Property Office on Sep. 29, 2021, the entire content of which is incorporated herein by reference.

### TECHNICAL FIELD

The present disclosure relates to an outer rotor motor. In more detail, the present disclosure relates to an outer rotor motor for an air conditioner.

### BACKGROUND

In general, an air conditioner is a device that creates a more comfortable indoor environment for users, and may control at least one of temperature, humidity, and cleanliness of air. For example, the indoor air is adjusted to a pleasantly clean state by adjusting a cool cooling state in summer and a warm heating state in winter, and adjusting the indoor humidity.

In detail, a refrigerant cycle is provided inside the air conditioner, and a phase-changed refrigerant and external air exchange heat through the refrigerant cycle. The refrigerant cycle includes a compressor that compresses refrigerant to high temperature and high pressure, a condenser in which the refrigerant passing through the compressor exchanges heat with outdoor air, an expander in which the refrigerant passing through the condenser expands to a low temperature and low pressure, and an evaporator in which the refrigerant passing through the expander exchanges heat with the indoor air. Here, when the air conditioner is used as a cooler, the condenser corresponds to an outdoor heat exchanger, and the evaporator corresponds to an indoor heat exchanger.

And, as is well known, the air conditioner may be roughly divided into a separate-type air conditioner in which an outdoor unit and an indoor unit are installed separately, and an integrated-type air conditioner in which the outdoor unit and the indoor unit are installed integrally, and may be divided into a small-capacity air conditioner and a large-capacity air conditioner according to the size of the capacity.

Recently, as large buildings such as large restaurants and hotels are built, the need for large air conditioners or multi-type air conditioners is increasing. The large air conditioner or multi-type air conditioner is equipped with an outer rotor motor.

In the outer rotor motor, a stator having a coil wound therein is installed, and a rotor is disposed on the outside of the stator as if a magnet surrounds the coil of the stator. That is, the outer rotor motor is mainly used in large-capacity air conditioners because the inertia is significantly increased because the rotor is disposed on the outside of the outer rotor motor to rotate due to the structure of the outer rotor motor.

The outer rotor motor uses a cooling wheel, a cooling fan, and a flow guide for heat dissipation, so the number of parts is large. Accordingly, there is a problem in that the fastening structure of the parts is complicated and the size of the outer rotor motor is increased.

### SUMMARY

The problem to be solved by the present disclosure is to provide an outer rotor motor capable of reducing the number of unnecessary parts.

In addition, the problem to be solved by the present disclosure is to provide an outer rotor motor capable of reducing the size of the product by simplifying the fastening structure of the parts.

Particular implementations of the present disclosure provide an outer rotor motor including a frame, a stator disposed at the frame, a coil disposed at the stator, a rotating shaft coupled to a central region of the frame and configured to rotate with respect to the frame, a cover coupled to the rotating shaft and surrounding the stator, and a magnet disposed at the cover and facing the stator. The cover includes a fan bracket projecting in a radial direction from a radially outer surface of the cover, and a plurality of blades extending in an axial direction at the radially outer surface of the cover.

In some implementations, the outer rotor motor can optionally include one or more of the following features. The frame may include a coupling portion extending in the axial direction and coupling the rotating shaft, the rotating shaft being configured to rotate relative to the coupling portion, and a flange portion extending in the radial direction from the coupling portion. The plurality of blades may be disposed between the fan bracket of the cover and the flange portion of the frame. The plurality of blades may have a first blade portion having a first radial height and a second blade portion having a second radial height greater than the first radial height. The flange portion may be closer to the first blade portion in the axial direction than to the second blade portion. The plurality of blades may extend from an axial surface of the fan bracket. The plurality of blades may extend to a region adjacent to an end of the cover. A maximum radial height of the plurality of blades may be equal to or less than a radial height of the fan bracket. A radially outer surface of the plurality of blades may be curved radially outward. A radially outer surface of the plurality of blades may be curved radially inward. The rotating shaft may be coupled to the central region of the frame with a bearing. An axial free end of the cover may be axially closer to the fan bracket than to an axial middle part of the rotating shaft.

Particular implementations of the present disclosure provide an outer rotor motor including a frame, a stator disposed at an outer circumferential surface of the coupling portion of the frame, a coil disposed at the stator, a rotating shaft coupled to the coupling portion, a cover coupled to the rotating shaft and surrounding the stator; and a magnet disposed at the cover and facing the stator. The frame includes a coupling portion extending in an axial direction, and a flange portion extending in a radial direction from the coupling portion. The cover includes a fan bracket projecting in the radial direction from a radially outer surface of the cover, and a plurality of blades positioned between an axial surface of the fan bracket and the radially outer surface of the cover.

In some implementations, the outer rotor motor can optionally include one or more of the following features. The plurality of blades may have a first blade portion having a first radial height and a second blade portion having a second radial height greater than the first radial height. The axial surface of the fan bracket may be closer to the second blade portion in the axial direction than to the first blade portion. A maximum radial height of the plurality of blades may be equal to or less than a radial height of the fan bracket. A radially outer surface of the plurality of blades may be curved radially outward. A radially outer surface of the plurality of blades may be curved radially inward.

Particular implementations of the present disclosure provide an outer rotor motor including a frame, a stator disposed at the frame, a coil disposed at the stator, a rotating shaft coupled to a central region of the frame and configured to rotate with respect to the frame, a cover coupled to the rotating shaft and surrounding the stator, and a magnet disposed at the cover and facing the stator. The cover includes a fan bracket projecting in a radial direction from a radially outer surface of the cover, and a plurality of protrusions extending in an axial direction at the radially outer surface of the cover.

In some implementations, the outer rotor motor can optionally include one or more of the following features. A width of at least some of the plurality of protrusions in a circumferential direction may decrease in the radial direction away from the radially outer surface of the cover. The plurality of protrusions may contact each other in a first region. A width of at least some of the plurality of protrusions in a circumferential direction may decrease in the radial direction away from the radially outer surface of the cover in the first region. A length in a circumferential direction of the plurality of protrusions may be twice a height of a region of the plurality of protrusions. A width of the region in the circumferential direction may decrease in the radial direction away from the radially outer surface of the cover.

An outer rotor motor according to an aspect of the present disclosure for achieving the above object may comprise a frame, a stator disposed on the frame, a coil disposed on the stator, a rotating shaft rotatably coupled to a central region of the frame, a cover coupled to the rotating shaft and surrounding the stator, and a magnet disposed on the cover and facing the stator.

In this case, the cover may include a fan bracket projecting in a radial direction from a radially outer surface, and a plurality of blades extending in an axial direction from the radially outer surface.

Through this, it is possible to increase the heat dissipation effect without a configuration such as a cooling wheel, a cooling fan and a flow guide, so it is possible to reduce the number of parts. In addition, it is possible to reduce the size of the product by simplifying the fastening structure of the parts.

In addition, the frame may include a coupling portion extending in the axial direction and to which the rotation shaft is rotatably coupled, and a flange portion extending in the radial direction in a rear region of the coupling portion, and the plurality of blades may be disposed between the fan bracket and the flange portion.

In addition, a radial height of the plurality of blades may decrease as the plurality of blades are adjacent to the flange portion.

In addition, the plurality of blades may extend rearward from an axial rear surface of the fan bracket.

In addition, the plurality of blades may extend to a region adjacent to a rear end of the cover.

In addition, the plurality of blades may be disposed inside in the radial direction than the radially outer surface of the fan bracket.

In addition, the radially outer surface of the plurality of blades may be formed to be convex outwardly.

In addition, the radially outer surface of the plurality of blades may be formed to be concave inwardly.

In addition, the rotating shaft may be rotatably bearing-coupled to a radially central region of the frame.

In addition, the fan bracket may be disposed axially forward than an axially central region of the rotating shaft.

An outer rotor motor according to an aspect of the present disclosure for achieving the above object may comprise a frame including a coupling portion extending in an axial direction and a flange portion extending in a radial direction in a rear region of the coupling portion, a stator disposed on an outer circumferential surface of the coupling portion, a coil disposed on the stator, a rotating shaft rotatably coupled to an inside of the coupling portion, a cover coupled to the rotating shaft and surrounding the stator, and a magnet disposed on the cover and facing the stator.

In this case, the cover may include a fan bracket projecting in a radial direction from a radially outer surface, and a plurality of blades formed between a rear surface of the fan bracket and the radially outer surface of the cover.

Through this, it is possible to increase the heat dissipation effect without a configuration such as a cooling wheel, a cooling fan and a flow guide, so it is possible to reduce the number of parts. In addition, it is possible to reduce the size of the product by simplifying the fastening structure of the parts.

In addition, a radial height of the plurality of blades may decrease as the plurality of blades move away from the rear surface of the fan bracket.

In addition, the plurality of blades may be disposed inside in the radial direction than the radially outer surface of the fan bracket.

In addition, the radially outer surface of the plurality of blades may be formed to be convex outwardly.

In addition, the radially outer surface of the plurality of blades may be formed to be concave inwardly.

An outer rotor motor according to an aspect of the present disclosure for achieving the above object may comprise a frame, a stator disposed on the frame, a coil disposed on the stator, a rotating shaft rotatably coupled to a central region of the frame, a cover coupled to the rotating shaft and surrounding the stator, and a magnet disposed on the cover and facing the stator.

In this case, the cover may include a fan bracket projecting in a radial direction from a radially outer surface, and a plurality of protrusions extending in an axial direction from the radially outer surface.

Through this, it is possible to increase the heat dissipation effect without a configuration such as a cooling wheel, a cooling fan and a flow guide, so it is possible to reduce the number of parts. In addition, it is possible to reduce the size of the product by simplifying the fastening structure of the parts.

In addition, a cross-sectional area of the plurality of protrusions may decrease as at least some of the plurality of protrusions go outward in the radial direction.

In addition, the plurality of protrusions may be in contact with adjacent protrusions each other.

In addition, the cross-sectional area of the plurality of protrusions may decrease as the plurality of protrusions go outward in the radial direction in a region in contact with the adjacent protrusions.

In addition, a length in a circumferential direction of the plurality of protrusions may be twice a height of a region in which the cross-sectional area of the plurality of protrusions decreases as the plurality of projections go outward in the radial direction.

Through the present disclosure, it is possible to provide an outer rotor motor capable of reducing the number of unnecessary parts.

In addition, through the present disclosure, it is possible to provide an outer rotor motor capable of reducing the size of the product by simplifying the fastening structure of the parts.

### BRIEF DESCRIPTION OF THE DRAWINGS

FIG. 1 is a perspective view of an outer rotor motor according to an embodiment of the present disclosure.

FIG. 2 is a cross-sectional view of an outer rotor motor according to an embodiment of the present disclosure.

FIG. 3 is a perspective view of a cover of an outer rotor motor according to an embodiment of the present disclosure.

FIGS. 4 to 7 are modified examples of a cover of an outer rotor motor according to an embodiment of the present disclosure.

FIG. 8 is a cross-sectional view of a partial area of a cover of an outer rotor motor according to FIG. 7.

FIG. 9 is a diagram illustrating a fluid flow of an outer rotor motor according to the prior art.

FIGS. 10 and 11 are diagrams illustrating a fluid flow of an outer rotor motor according to an embodiment of the present disclosure.

### DETAILED DESCRIPTION

Hereinafter, embodiments disclosed in the present disclosure will be described in detail with reference to the accompanying drawings, however, regardless of the reference numerals, the same or similar components will be given the same reference numerals and redundant description thereof will be omitted.

In describing the embodiments disclosed in the present disclosure, when a component is referred to as being “connected” or “accessed” to other component, it may be directly connected or accessed to the other component, however, it may be understood that other components may be present in the middle.

In addition, in describing the embodiments disclosed in the present disclosure, when it is determined that the detailed description of the related known technology may obscure the subject matter of the embodiments disclosed in the present disclosure, the detailed description thereof will be omitted. In addition, the accompanying drawings are only for easily understanding the embodiments disclosed in the present disclosure, the technical spirit disclosed in the present disclosure is not limited by the accompanying drawings, and it should be understood that the accompanying drawings include all changes, equivalents, and substitutes included in the spirit and scope of the present disclosure.

On the other hand, terms of disclosure may be replaced with terms such as document, specification, description.

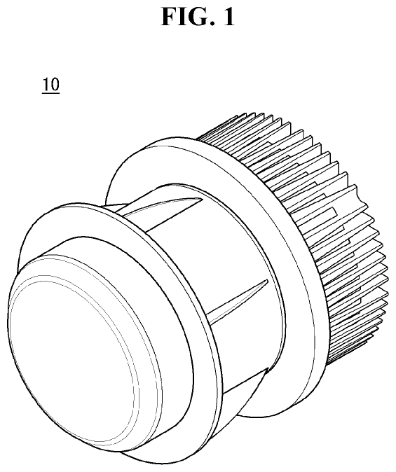

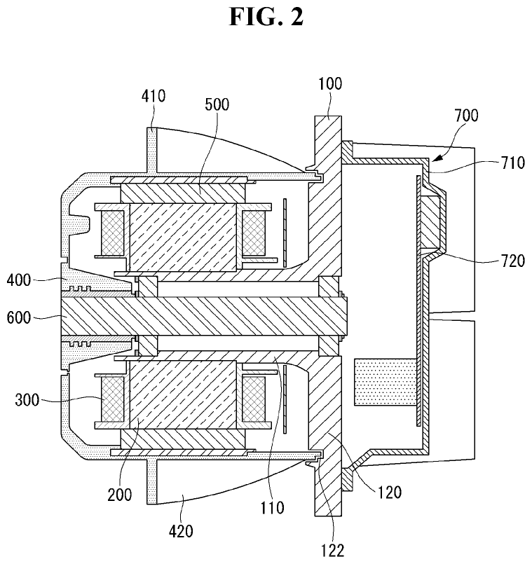

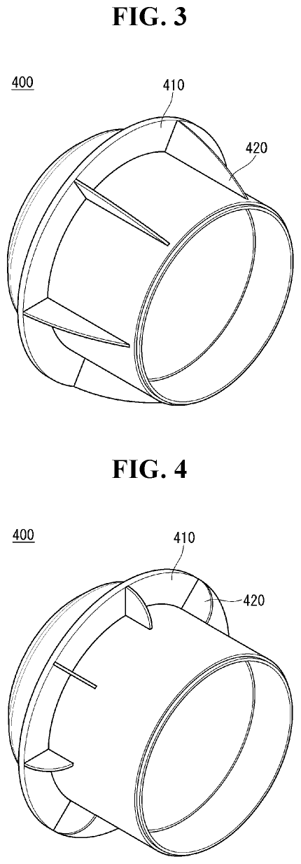

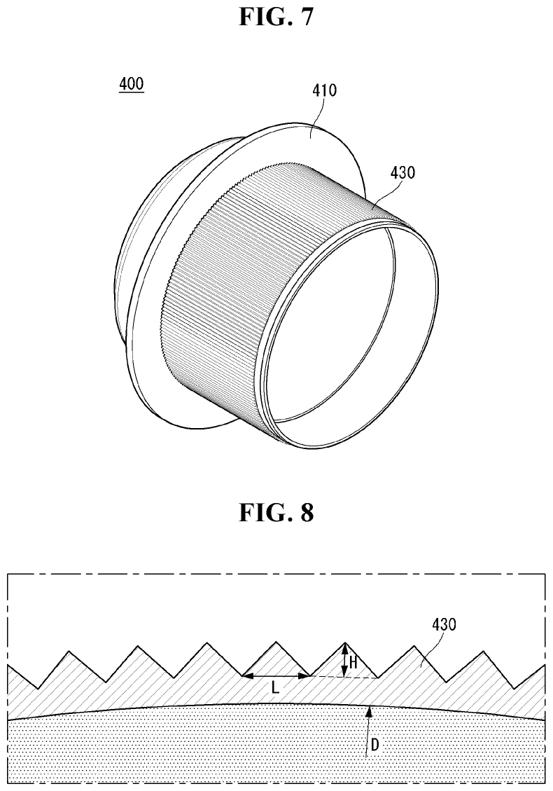

FIG. 1 is a perspective view of an outer rotor motor according to an embodiment of the present disclosure. FIG. 2 is a cross-sectional view of an outer rotor motor according to an embodiment of the present disclosure. FIG. 3 is a perspective view of a cover of an outer rotor motor according to an embodiment of the present disclosure. FIGS. 4 to 7 are modified examples of a cover of an outer rotor motor according to an embodiment of the present disclosure. FIG. 8 is a cross-sectional view of a partial area of a cover of an outer rotor motor according to FIG. 7.

Referring to FIGS. 1 to 3, an outer rotor motor 10 according to an embodiment of the present disclosure may includes a frame 100, a stator 200, a coil 300, a cover 400, a magnet 500, and a rotating shaft 600, and a controller 700, but may be implemented except for some of the configurations, and does not exclude additional configurations.

In one embodiment of the present disclosure, it may be understood that the left side refers to a front in an axial direction and the right side refers to a rear in the axial direction with reference to FIG. 2, and the axial direction may be understood to mean a left-right direction in which the rotating shaft 600 extends with reference to FIG. 2.

The frame 100 may be disposed at the rear of the cover 400. The stator 200, the coil 300, the magnet 500, and the rotating shaft 600 may be disposed between the frame 100 and the cover 400. The controller 700 may be coupled to the rear surface of the frame 100.

The frame 100 may include a coupling portion 110. The coupling portion 110 may extend in the axial direction. The coupling portion 110 may include a long hole formed in the central region and extending in the axial direction. The rotating shaft 600 may be disposed in the long hole of the coupling portion 110. The rotating shaft 600 may be rotatably coupled to the coupling portion 110. The rotating shaft 600 may be bearing-coupled to the coupling portion 110.

The frame 100 may include a flange portion 120. The flange portion 120 may extend in a radial direction from the rear of the coupling portion 110. The controller 700 may be coupled to the rear surface of the flange portion 120. The cover 400 may be disposed in front of the flange portion 120. The flange portion 120 may include a groove 122 in which a rear end of the cover 400 is disposed. Through this, it is possible to prevent the cover 400 from being separated to the outside by rotation.

The stator 200 may be disposed on the frame 100. The stator 200 may be disposed on the coupling portion 110 of the frame 100. The stator 200 may be disposed on an outer circumferential surface of the coupling portion 110 of the frame 100. The stator 200 may be formed in a cylindrical shape. Alternatively, the stator 200 may be formed of a plurality of stator units spaced apart in a circumferential direction. The stator 200 may face the magnet 500. The stator 200 may be disposed inside the magnet 500. The stator 200 may be spaced apart from the magnet 500 by a predetermined distance. The stator 200 may be fixed to the coupling portion 110 of the frame 100.

The coil 300 may be disposed on the stator 200. The coil 300 may be wound around the stator 200. The coil 300 may be electrically connected to the controller 700.

The cover 400 may be formed in a shape in which the rear surface is opened. The cover 400 may be coupled to the rotating shaft 600. The central region of the front surface of the cover 400 may be penetrated by the rotating shaft 600. The rotating shaft 600 may be coupled to the central region of the front surface of the cover 400. The cover 400 may surround the stator 200 and the coil 300. The side surface of the cover 400 may surround the stator 200 and the coil 300. The magnet 500 may be disposed on the cover 400. The magnet 500 may be coupled to the inside of the side surface of the cover 400. The rear end of the cover 400 may be disposed in the groove 122 of the flange portion 120 of the frame 100. The rear end of the side surface of the cover 400 may be disposed in the groove 122 of the flange portion 120 of the frame 100.

The cover 400 may include a fan bracket 410. The fan bracket 410 may extend in the radial direction from an outer circumferential surface of the cover 400. The fan bracket 410 may extend in the radial direction from the outside of the side surface of the cover 400. Although the fan bracket 410 is described as an example formed integrally with the cover 400, it may be made of a separate member and coupled to the cover 400. The fan bracket 410 may be coupled to a fan 20 disposed in front of the outer rotor motor 10. The fan bracket 410 may be disposed axially forward than an axially central region of the rotating shaft 600. The fan bracket 410 may be disposed axially forward than an axially central region of the stator 200.

The cover 400 may include a plurality of blades 420. The plurality of blades 420 may be formed on the outer circumferential surface of the cover 400. The plurality of blades 420 may be formed on an outer surface of the side surface of the cover 400. The plurality of blades 420 may extend in the radial direction from the outer circumferential surface of the cover 400. The plurality of blades 420 may extend in the radial direction from the outer surface of the side surface of the cover 400. The plurality of blades 420 may extend in the axial direction. The plurality of blades 420 may extend in the axial direction from the outer circumferential surface of the cover 400. The plurality of blades 420 may extend in the axial direction from the outer surface of the side surface of the cover 400. The plurality of blades 420 may be spaced apart from each other in the circumferential direction.

The plurality of blades 420 may be disposed between the fan bracket 410 and the flange portion 120 of the frame 100. Front regions of the plurality of blades 420 may be disposed on the rear surface of the fan bracket 410. The plurality of blades 420 may extend rearward from the rear surface of the fan bracket 410. At least a portion of the plurality of blades 420 may be disposed inside in the radial direction than the radially outer surface of the fan bracket 410. The plurality of blades 420 may be axially spaced apart from the flange portion 120 of the frame 100. The plurality of blades 420 may extend to a region adjacent to the rear end of the cover 400.

Through this, when the cover 400 rotates in the circumferential direction, the plurality of blades 420 may generate a flow of fluid between the fan bracket 410 and the flange portion 120 of the frame 100. That is, it is possible to improve the heat dissipation performance of the cover 400 and inner parts of the cover 400 by convection.

Specifically, since the flow of fluid occurs between the fan bracket 410 and the flange portion 120 of the frame 100, it is possible to improve the heat dissipation performance of the inner parts of the cover 400 through the space between the cover 400 and the flange portion 120 of the frame 100. Since it is possible to increase the heat dissipation effect without a separate configuration such as a cooling wheel, a cooling fan and a flow guide, it is possible to reduce the number of parts of the outer rotor motor 10. In addition, it is possible to reduce the size of the outer rotor motor 10 by simplifying the fastening structure of the parts.

A radial height of the plurality of blades 420 decreases as the plurality of blades move away from the fan bracket 410. The radial height of the plurality of blades 420 decreases as the plurality of blades are adjacent to the flange portion 120 of the frame 100. The radially outer surface of the plurality of blades 420 may be formed to be convex outwardly. The heat dissipation performance may be improved by increasing the flow of fluid between the fan bracket 410 and the flange portion 120 by forming the radially outer surfaces of the plurality of blades 420 to be formed to be convex toward the outer surface compared to the radially outer surface of the plurality of blades 420 formed in a straight shape.

The magnet 500 may be disposed on the cover 400. The magnet 500 may be disposed on the inner surface of the cover 400. The magnet 500 may face the stator 200. The magnet 500 may be disposed to surround the stator 200. The magnet 500 may rotate the cover 400, the rotating shaft 600, and the fan 20 in the circumferential direction through electromagnetic interaction with an electric field generated in the stator 200 due to the coil 300.

The rotating shaft 600 may be rotatably coupled to the frame 100. The rotating shaft may be rotatably coupled to a radially central region of the frame 100. The rotating shaft 600 may be rotatably coupled to the coupling portion 110 of the frame 100. For example, the rotating shaft 600 may be bearing-coupled to the coupling portion 110 of the frame 100.

The rotating shaft 600 may be coupled to the fan 20. The front region of the rotating shaft 600 may be coupled to the fan 20. The rotating shaft 600 may pass through the cover 400. The rotating shaft 600 may pass through the central region of the front surface of the cover 400. The rotating shaft 600 may be coupled to the front surface of the cover 400. Through this, the rotating shaft 600 may rotate integrally with the cover 400.

The controller 700 may be coupled to the frame 100. The controller 700 may be electrically connected to the coil 300. The controller 700 may be coupled to the rear surface of the flange portion 120 of the frame 100. The controller 700 may include a coupling member 710 coupled to the rear surface of the flange portion 120 of the frame 100 and a substrate 720 disposed on the coupling member 710 and electrically connected to the coil 300. The substrate 720 may be a printed circuit board (PCB). A heat sink capable of dissipating heat generated by the controller 700 may be installed on the rear surface of the controller 700.

Referring to FIG. 4, the plurality of blades 420 may be formed between the rear surface of the fan bracket 410 and the radially outer surface or the outer circumferential surface of the cover 400. Specifically, the plurality of blades 420 may be in contact with the rear surface of the fan bracket 410 and may be in contact with the radially outer surface or the outer circumferential surface of the cover 400. The cross-sections of the plurality of blades 420 may have a partial shape of a circle or an ellipse. The cross-section of the plurality of blades 420 may have an arc shape. The plurality of blades 420 may be spaced apart from each other in the circumferential direction. The radial height of the plurality of blades decreases as the plurality of blades move away from the rear surface of the fan bracket. At least a portion of the plurality of blades 420 may be disposed inside in the radial direction than the radially outer surface of the fan bracket 410. The radially outer surface of the plurality of blades may be formed to be convex outwardly.

The plurality of blades 420 according to FIG. 4 may be formed to have a shorter axial length than the plurality of blades 420 according to FIG. 3. Although the heat dissipation performance is somewhat lower than that of the plurality of blades 420 according to FIG. 3, it is possible to reduce the decrease in output of the outer rotor motor 10 while improving manufacturing easiness. For example, in the plurality of blades 420 according to FIG. 4, the flow resistance of the fluid around the cover 400 is reduced compared to the plurality of blades 420 according to FIG. 3, so there is an advantage in that the output loss of the outer rotor motor 10 is reduced.

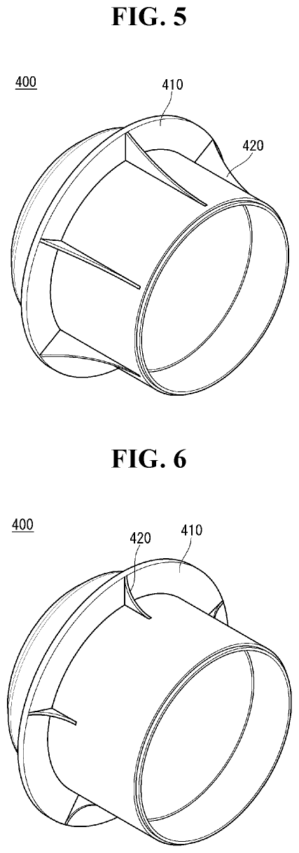

Referring to FIG. 5, the radially outer surfaces of the plurality of blades 420 may be formed to be concave inwardly. That is, it can be understood that the radially outer surfaces of the plurality of blades 420 according to FIG. 5 are formed to be concave inwardly in the radial direction compared to the plurality of blades 420 according to FIG. 3. In this case, the heat dissipation performance is somewhat lower than that of the plurality of blades 420 according to FIG. 3, but there is an advantage of reducing the decrease in the output of the outer rotor motor 10. For example, in the plurality of blades 420 according to FIG. 5, the flow resistance of the fluid around the cover 400 is reduced compared to the plurality of blades 420 according to FIG. 3, so there is an advantage in that the output loss of the outer rotor motor 10 is reduced.

Referring to FIG. 6, the radially outer surfaces of the plurality of blades 420 may be formed to be concave inwardly. That is, it can be understood that the radially outer surfaces of the plurality of blades 420 according to FIG. 6 are formed to be concave inwardly in the radial direction compared to the plurality of blades 420 according to FIG. 4. In this case, the heat dissipation performance is somewhat lower than that of the plurality of blades 420 according to FIG. 4, but there is an advantage of reducing the decrease in the output of the outer rotor motor 10. For example, in the plurality of blades 420 according to FIG. 6, the flow resistance of the fluid around the cover 400 is reduced compared to the plurality of blades 420 according to FIG. 4, so there is an advantage in that the output loss of the outer rotor motor 10 is reduced.

Referring to FIGS. 7 and 8, the cover 400 may include a plurality of protrusions 430 extending in the axial direction from the radially outer surface or the outer circumferential surface of the cover 400. The plurality of protrusions 430 may be in contact with adjacent protrusions each other. The plurality of protrusions 430 may extend from the rear surface of the fan bracket 410 to a region adjacent to the flange portion 120 of the frame 100. A cross-sectional area of the plurality of protrusions 430 may decrease as at least some of the plurality of protrusions 430 go outward in the radial direction. Specifically, the cross-sectional area of the plurality of protrusions 430 may decrease as the plurality of protrusions 430 go outward in the radial direction from a region in contact with the adjacent protrusions.

The plurality of protrusions 430 has the advantage of reducing loss resistance because the flow resistance of the surrounding fluid is reduced due to the shape of the plurality of protrusions 430 compared to the plurality of blades 420.

A length L in the circumferential direction of the plurality of protrusions 430 may be twice a height H of a region in which the cross-sectional area of the plurality of projections 430 decreases toward the outside in the radial direction. In this case, compared to the plurality of protrusions 430 having the same cooling performance, it is possible to reduce the output loss of the outer rotor motor 10 by about ⅓.

In one embodiment of the present disclosure, the plurality of protrusions 430 have been described as being in contact with each other, but otherwise, the plurality of protrusions 430 may be spaced apart from each other in the circumferential direction. In this case, the adjacent protrusions may be disposed adjacent to each other in the circumferential direction. In this case, the heat dissipation performance can be further improved.

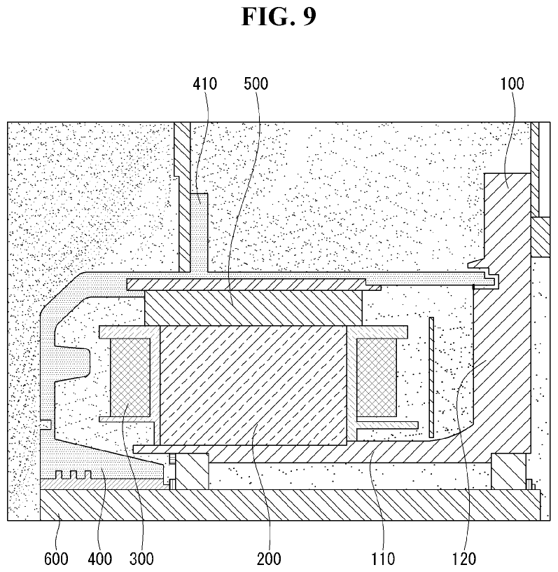

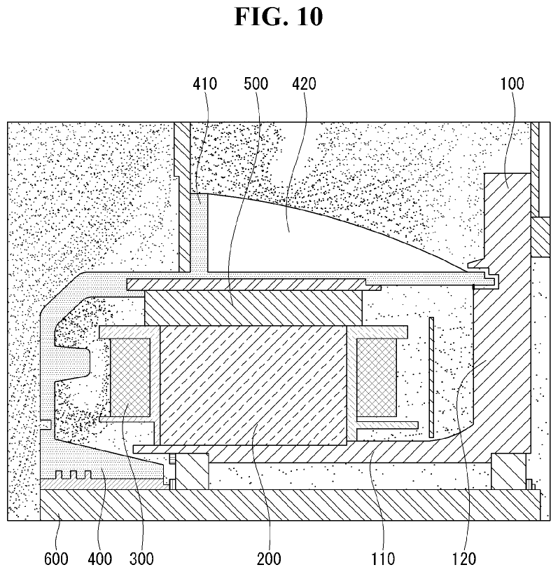

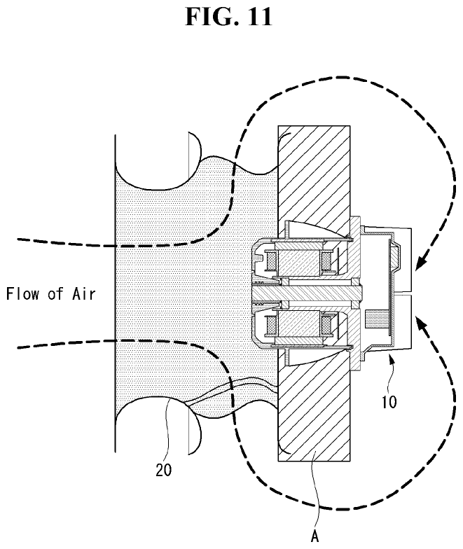

FIG. 9 is a diagram illustrating a fluid flow of an outer rotor motor according to the prior art. FIGS. 10 and 11 are diagrams illustrating a fluid flow of an outer rotor motor according to an embodiment of the present disclosure.

Referring to FIG. 9, in the case of the outer rotor motor according to the prior art, the flow of fluid hardly occurs between the fan bracket 410 and the frame 100.

Referring to FIGS. 10 and 11, it can be seen that in the case of the outer rotor motor 10 according to an embodiment of the present disclosure, the fluid flow occurs more smoothly between the fan bracket 410 and the frame 100 compared to the prior art. That is, the outer rotor motor 10 according to an embodiment of the present disclosure may improve the heat dissipation performance of the cover 400 and the inner parts of the cover 400 by convection.

Specifically, since the flow of fluid occurs between the fan bracket 410 and the flange portion 120 of the frame 100, it is possible to improve the heat dissipation performance of the inner parts of the cover 400 through the space between the cover 400 and the flange portion 120 of the frame 100. Since the outer rotor motor 10 according to an embodiment of the present disclosure can increase the heat dissipation effect without a separate configuration such as a cooling wheel, a cooling fan and a flow guide, it is possible to reduce the number of parts of the outer rotor motor 10. In addition, it is possible to reduce the size of the outer rotor motor 10 by simplifying the fastening structure of the parts.

Some or other embodiments of the present disclosure described above are not exclusive or distinct from one another. Some or other embodiments of the present disclosure described above may be used in combination or combined with each configuration or function.

For example, it means that configuration A described in specific embodiments and/or drawings and configuration B described in other embodiments and/or drawings may be combined. In other words, even when the combination between the components is not described directly, it means that the combination is possible except when it is described as not possible to combine.

The above detailed description should not be construed as limiting in all respects and should be considered as illustrative. The scope of the present disclosure should be determined by reasonable interpretation of the appended claims, and all changes within the equivalent scope of the present disclosure are included in the scope of the present disclosure.

What is claimed is:

1. An outer rotor motor comprising:
a frame;
a stator disposed at the frame;
a coil disposed at the stator;
a rotating shaft coupled to a central region of the frame and configured to rotate with respect to the frame;
a cover coupled to the rotating shaft and surrounding the stator; and
a magnet disposed at the cover and facing the stator,
wherein the cover includes:
a fan bracket projecting in a radial direction from a radially outer surface of the cover, and
a plurality of blades extending in an axial direction at the radially outer surface of the cover.

2. The outer rotor motor of claim 1, wherein the frame includes:
a coupling portion extending in the axial direction and coupling the rotating shaft, the rotating shaft being configured to rotate relative to the coupling portion, and
a flange portion extending in the radial direction from the coupling portion, and
wherein the plurality of blades are disposed between the fan bracket of the cover and the flange portion of the frame.

3. The outer rotor motor of claim 2, wherein the plurality of blades has a first blade portion having a first radial height and a second blade portion having a second radial height greater than the first radial height, the flange portion being closer to the first blade portion in the axial direction than to the second blade portion.

4. The outer rotor motor of claim 1, wherein the plurality of blades extend from an axial surface of the fan bracket.

5. The outer rotor motor of claim 4, wherein the plurality of blades extend to a region adjacent to an end of the cover.

6. The outer rotor motor of claim 1, wherein a maximum radial height of the plurality of blades is equal to or less than a radial height of the fan bracket.

7. The outer rotor motor of claim 1, wherein a radially outer surface of the plurality of blades is curved radially outward.

8. The outer rotor motor of claim 1, wherein a radially outer surface of the plurality of blades is curved radially inward.

9. The outer rotor motor of claim 1, wherein the rotating shaft is coupled to the central region of the frame with a bearing.

10. The outer rotor motor of claim 1, wherein an axial free end of the cover is axially closer to the fan bracket than to an axial middle part of the rotating shaft.

11. An outer rotor motor comprising:
a frame including:
a coupling portion extending in an axial direction, and
a flange portion extending in a radial direction from the coupling portion;
a stator disposed at an outer circumferential surface of the coupling portion of the frame;
a coil disposed at the stator;
a rotating shaft coupled to the coupling portion;
a cover coupled to the rotating shaft and surrounding the stator; and
a magnet disposed at the cover and facing the stator,
wherein the cover includes:
a fan bracket projecting in the radial direction from a radially outer surface of the cover, and
a plurality of blades positioned between an axial surface of the fan bracket and the radially outer surface of the cover.

12. The outer rotor motor of claim 11, wherein the plurality of blades has a first blade portion having a first radial height and a second blade portion having a second radial height greater than the first radial height, the axial surface of the fan bracket being closer to the second blade portion in the axial direction than to the first blade portion.

13. The outer rotor motor of claim 11, wherein a maximum radial height of the plurality of blades is equal to or less than a radial height of the fan bracket.

14. The outer rotor motor of claim 11, wherein a radially outer surface of the plurality of blades is curved radially outward.

15. The outer rotor motor of claim 11, wherein a radially outer surface of the plurality of blades is curved radially inward.

16. An outer rotor motor comprising:
a frame;
a stator disposed at the frame;
a coil disposed at the stator;
a rotating shaft coupled to a central region of the frame and configured to rotate with respect to the frame;
a cover coupled to the rotating shaft and surrounding the stator; and
a magnet disposed at the cover and facing the stator,
wherein the cover includes:
a fan bracket projecting in a radial direction from a radially outer surface of the cover, and
a plurality of protrusions extending in an axial direction at the radially outer surface of the cover.

17. The outer rotor motor of claim 16, wherein a width of at least some of the plurality of protrusions in a circumferential direction decreases in the radial direction away from the radially outer surface of the cover.

18. The outer rotor motor of claim 16, wherein the plurality of protrusions contact each other in a first region.

19. The outer rotor motor of claim 18, wherein a width of at least some of the plurality of protrusions in a circumferential direction decreases in the radial direction away from the radially outer surface of the cover in the first region.

20. The outer rotor motor of claim 16, wherein a length in a circumferential direction of the plurality of protrusions is twice a height of a region of the plurality of protrusions, a width of the region in the circumferential direction decreasing in the radial direction away from the radially outer surface of the cover.
